(19) United States
(12) Patent Application Publication
(10) Pub. No.: US 2014/0351149 A1
(43) Pub. Date: Nov. 27, 2014

(54) REPLACEMENT CANDIDATE PRESENTATION METHOD AND INFORMATION PROCESSING APPARATUS

(71) Applicant: FUJITSU LIMITED, Kawasaki-shi (JP)

(72) Inventor: Akira MINEGISHI, Setagaya (JP)

(21) Appl. No.: 14/452,573

(22) Filed: Aug. 6, 2014

Related U.S. Application Data
(63) Continuation of application No. PCT/JP2012/057651, filed on Mar. 23, 2012.

(51) Int. Cl. G06Q 10/00

(52) U.S. Cl. CPC G06Q 10/20
USPC 705/305

(57) ABSTRACT

A computer stores configuration information that indicates the inclusion relationship between a plurality of replacement units in a target apparatus that is a target of a replacement work by identification information that identifies the plurality of replacement units. The computer determines, according to the configuration information, first identification information indicating a first replacement unit that includes a second replacement unit in the target apparatus indicated by second identification information included in report information transmitted from the target apparatus. Then, the computer outputs replacement candidate information including the first identification information for indicating that the first replacement unit is a replacement candidate.

### CROSS-REFERENCE TO RELATED APPLICATION

This application is a continuation application of International Application PCT/JP2012/057651 filed on Mar. 23, 2012 and designated the U.S., the entire contents of which are incorporated herein by reference.

### FIELD

The embodiments discussed herein are related to a replacement candidate presentation method and an information processing apparatus.

### BACKGROUND

In an information processing system such as a data center, a maintenance work is performed for a maintenance target apparatus according to the state of occurrence of a fault or the like in the hardware. The maintenance target apparatus is an apparatus to be the target of the maintenance work, and its chassis is equipped with various pieces of hardware such as a server, a network apparatus, a storage apparatus, and the like. In the maintenance work, for example, a work to replace a failed component in the hardware or the like is performed. When a component fails, the maintenance target apparatus transmits a report message for reporting an event such as occurrence of a failure or the like to the maintenance center, and a maintenance operator of the maintenance center decides the component to be replaced according to the received report message.

A method is known in which the maintenance work is supported according to shipment information in which the identification information of a device and the shipment destination of the device are associated, and equipment maintenance information in which the identification information of the device, the identification information of the customer who uses the device, and information of the time of occurrence of a failure are associated. In this method, a population as a set of devices shipped to a prescribed shipment destination is calculated, a history of failures of devices that have occurred in the population before the point of time at which the reliability analysis is performed is obtained according to the equipment maintenance information, and the reliability analysis is performed according to the population and the history of failures.

A maintenance operation support method in which an efficient maintenance procedure is displayed in a computer operating service work is also known. In this method, information collecting works are arranged in order of processing priority, according to the processing time of each of the information collecting works which were performed in processing fault cases and a work history including the transition in the information collecting work and the solving measure for each of the fault cases. Next, an information collecting work for which a solving measure is used with higher priority is preferentially associated with the solving measure, according to the number of cases indicating that processes were performed in the order of information collecting works included in the work history. Then, a maintenance procedure is displayed according to the arrangement result of the information collecting works and the associated solving measures.

A controller with which information of a component before replacement may be easily obtained is also known. This controller obtains a fault message including information of a failed component from a connected apparatus, and it associates and stores the failure message with information of the failed component and a replaced component.
Patent document 1: Japanese Laid-open Patent Publication No. 2005-327201
Patent document 2: International Publication Pamphlet No. WO2009/150737
Patent document 3: International Publication Pamphlet No. WO2009/110069

### SUMMARY

According to an aspect of the embodiments, a memory stores configuration information that indicates the inclusion relationship between a plurality of replacement units in a target apparatus that is a target of a replacement work by identification information that identifies the plurality of replacement units. A replacement candidate presentation method executed by a computer determines, according to the configuration information stored in the memory, first identification information indicating a first replacement unit that includes a second replacement unit in the target apparatus indicated by second identification information included in report information transmitted from the target apparatus. Then, the replacement candidate presentation method outputs replacement candidate information including the first identification information for indicating that the first replacement unit is a replacement candidate.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram of a data center;

FIG. 2 is a configuration of a management server;

FIG. 3 is a flowchart of a first replacement candidate presentation process;

FIG. 4 is a functional configuration diagram of a processing unit;

FIG. 5 is a diagram illustrating information stored in a storing unit;

FIG. 6 is a diagram illustrating the format of a report message;

FIG. 7 is a configuration diagram of a target apparatus;

FIG. 8 is a diagram illustrating configuration information;

FIG. 9 is a diagram illustrating history information;

FIG. 10 is a diagram illustrating maintenance policy information;

FIG. 11 is a diagram illustrating the format of a maintenance message;

FIG. 12 is a flowchart of a second replacement candidate presentation process;

FIG. 13 is a diagram illustrating a data center that includes duplex servers;

FIG. 14 is a flowchart of a message analysis process;

FIG. 15 is a flowchart of a history analysis process;

FIG. 16 is a flowchart of a maintenance policy obtaining process;

FIG. 17 is a flowchart of a replacement unit analysis process;

FIG. 18 is a flowchart of a process to change history information and maintenance policy information; and

FIG. 19 is a configuration diagram of an information processing apparatus.

### DESCRIPTION OF EMBODIMENTS

The conventional maintenance work has the following problems.

In a case in which a maintenance work such as replacement of a component is to be performed every time when a maintenance server of a maintenance center receives a report message from a maintenance target apparatus, replacement of a component is performed for every report message, even when a plurality of components fail in the same maintenance target apparatus. In this case, replacement of a component is to be repeated a number of times for the same target apparatus, which makes the maintenance work troublesome.

Especially in a data center, a complicated information processing system in which a plurality of servers, a plurality of network apparatuses, a plurality of storage apparatuses, and the like are combined, or an information processing system constituted by a number of maintenance target apparatuses is often used. In such an information processing system, the maintenance work tends to be more troublesome and the workload for the maintenance operator who conducts the failure analysis or the like tends to increase, because a large number of report messages may be generated.

Hereinafter, embodiments are described in detail with reference to the drawings.

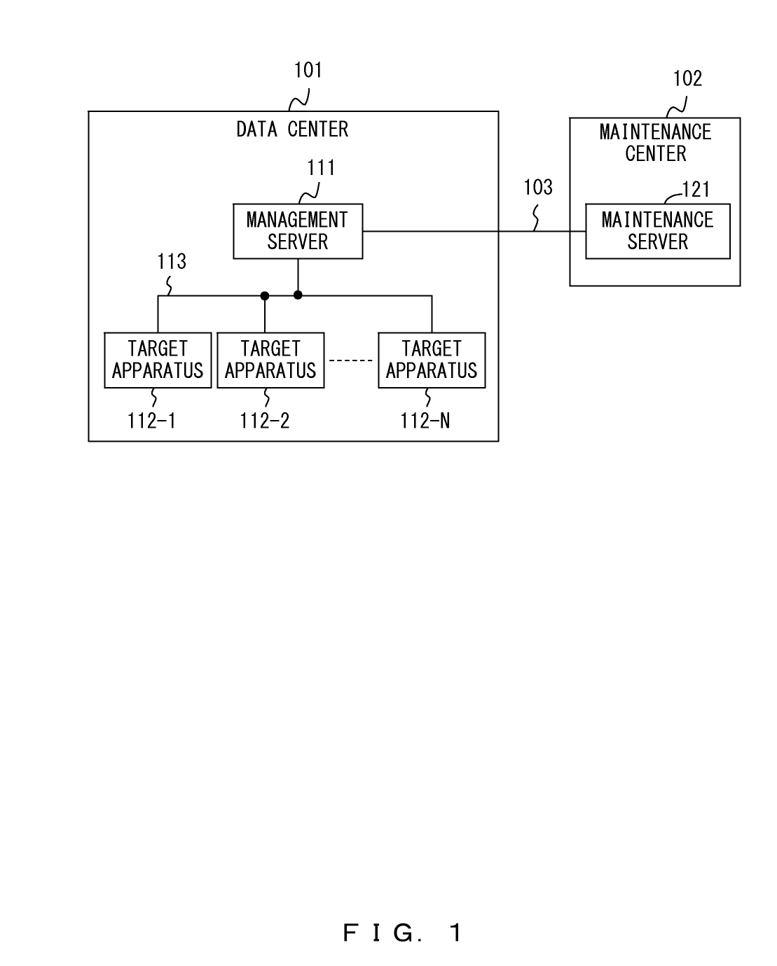

FIG. 1 illustrates a configuration example of an information processing system of a data center. A data center 101 in FIG. 1 includes a management server 111 and N target apparatuses 112-1 through 112-N (N is an integer of 1 or more). Hereinafter, one of the target apparatus 112-1 through the target apparatus 112-N may be indicated and referred to as the target apparatus 112.

The target apparatus 112-1 through the target apparatus 112-N are apparatuses to be the target of the maintenance work including a replacement work, and they communicate with the management server 111 through a communication network 113 that is a Local Area Network (LAN) or the like. The chassis of the target apparatus 112 is equipped with one type or multiple types of pieces of hardware including a server, a network apparatus, a storage apparatus, and the like.

The management server 111 is an information processing apparatus (a computer) that performs a replacement candidate presentation process according to report information sent from the target apparatus 112-1 through the target apparatus 112-N, and it communicates with a maintenance server 121 of a maintenance center 102 via a communication network 103. Report information sent from the target apparatus 112-1 through the target apparatus 112-N, replacement candidate information, and the like are transmitted from the management server 111 to the maintenance server 121.

For example, a report message is used as the report information. Besides the report message, information such as text data, voice data, image data, and the like may be used as the report information.

The maintenance server 121 is an information processing apparatus that displays replacement candidate information received from the management server 111 and the like on a display screen. The maintenance operator of the maintenance center 102 may perform a work to replace a replacement unit of the target apparatus 112-1 through the target apparatus 112-N according to the displayed replacement candidate information.

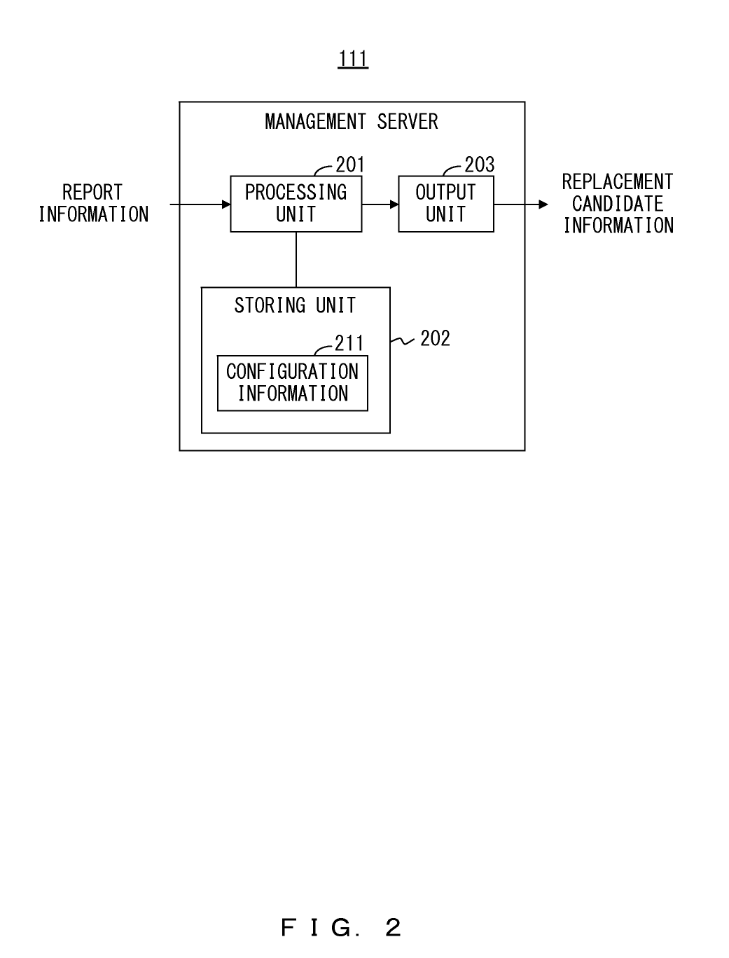

FIG. 2 illustrates a configuration example of the management server 111 in FIG. 1. The management server 111 in FIG. 2 includes a processing unit 201, a storing unit 202, and an output unit 203 (an output interface). The storing unit 202 stores configuration information 211 that indicates the inclusion relationship between replacement units by identification information that identifies a plurality of replacement units in the target apparatus 112.

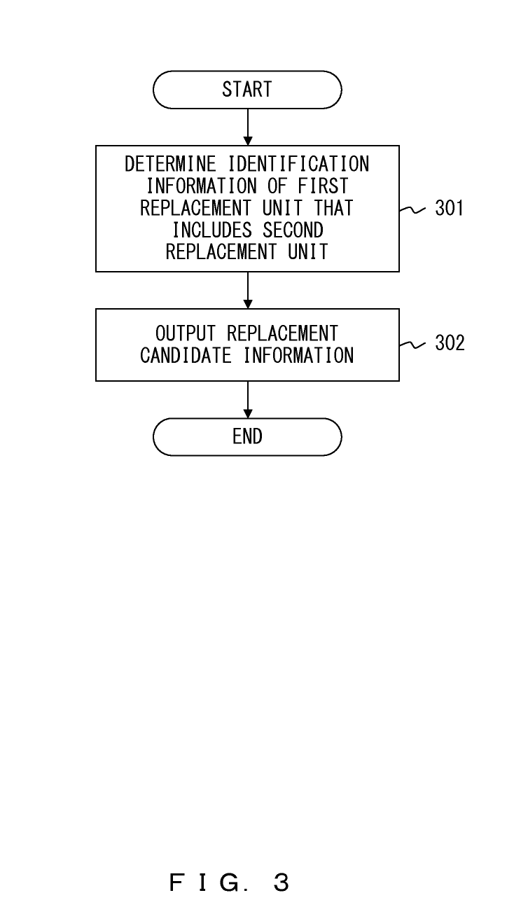

FIG. 3 is a flowchart illustrating an example of a replacement candidate presentation process performed by the management server 111 in FIG. 2. The processing unit 201 determines first identification information indicating a first replacement unit that includes a second replacement unit in the target apparatus indicated by second identification information included in report information transmitted from the target apparatus 112, according to the configuration information 211 stored in the storing unit 202 (step 301).

The output unit 203 outputs replacement candidate information that includes the first identification information for indicating that the first replacement unit is a replacement candidate (step 302). At this time, the output unit 203 may output the replacement candidate information to a display provided in the management server 111, or it may transmit the replacement candidate information to the maintenance server 121.

According to such a replacement candidate presentation process as the one described above, the maintenance work based on report information from the target apparatus 112 may be simplified.

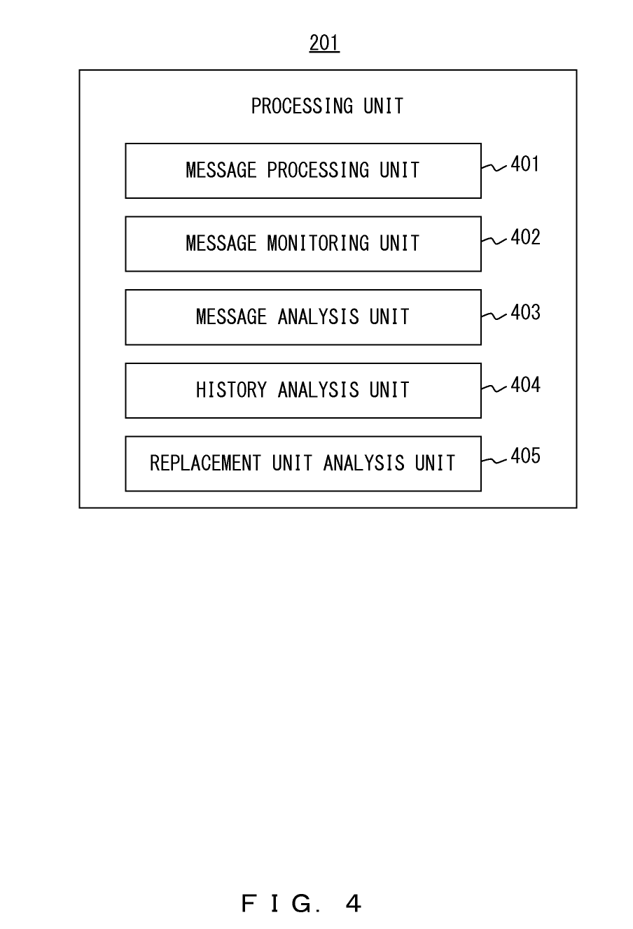

FIG. 4 is a functional configuration example of the processing unit 201 in FIG. 2. The processing unit 201 in FIG. 4 includes a message processing unit 401, a message monitoring unit 402, a message analysis unit 403, a history analysis unit 404, and a replacement unit analysis unit 405. Processes performed by these functional units are explained later.

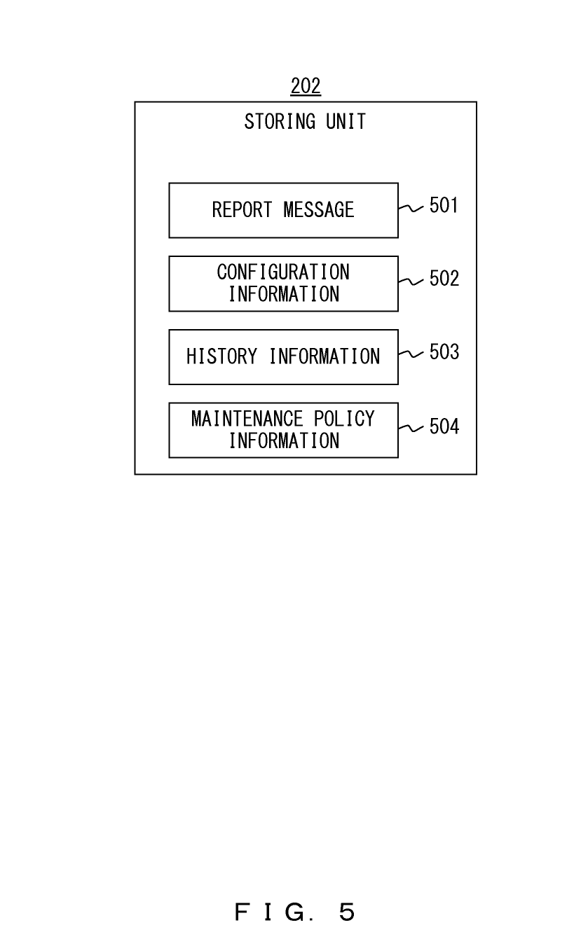

FIG. 5 illustrates an example of information stored in the storing unit 202 in FIG. 2. The storing unit 202 in FIG. 5 stores report message 501, configuration information 502, history information 503, and maintenance policy information 504.

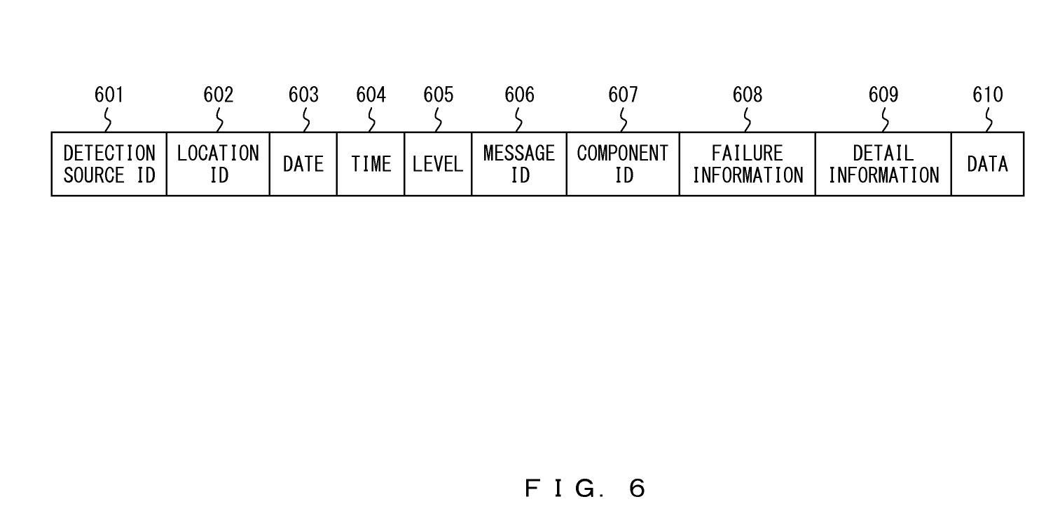

The report message 501 is one or more report message(s) transmitted from the target apparatus 112-1 through the target apparatus 112-N, which is (are) appropriately forwarded to the maintenance server 121. Each report message is in a format such as that illustrated in FIG. 6, for example.

The report message in FIG. 6 includes DETECTION SOURCE ID 601, LOCATION ID 602, DATE 603, TIME 604, LEVEL 605, MESSAGE ID 606, COMPONENT ID 607, FAILURE INFORMATION 608, DETAIL INFORMATION 609, and DATA 610.

The DETECTION SOURCE ID 601 is the identification information of a system monitoring apparatus that detected a failure event, and the LOCATION ID 602 is the identification information that indicates the location at which the failure event occurred in in the target apparatus 112. The LOCATION ID 602 includes, for example, the identification information of the chassis of the target apparatus 112, and identification information that identifies a partition in the target apparatus 112. The DATE 603 and the TIME 604 represent the date and time of the detection of the failure event.

The LEVEL 605 is information that indicates the fault level of the failure event. For example, for a serious failure that affects the continuation of the operation of the information processing system, the level E representing an error is set as the LEVEL 605. Meanwhile, for a case in which the information processing system is able to continue its operation, the level W representing a warning is set as the LEVEL 605, and for a mere notification of information, the level I is set as the LEVEL 605.

The MESSAGE ID 606 is the identification information that indicates the type of the report message, defined in accordance with the operation policy of the maintenance work or the like, and the COMPONENT ID 607 is the identification information that indicates the component in which the failure event occurred (the failed component). The operation policy of the maintenance work is created in accordance with an agreement between the maintenance operator of the maintenance center 102 and an owner who owns the data center 101 and implements the work.

The FAILURE INFORMATION 608 is information that indicates the content of the failure event, and the DETAIL INFORMATION 609 is information that indicates details of a failed component. For example, the component number, the serial number, the model name, and the like of the failed component are set as the DETAIL INFORMATION 609. The DATA 610 are data such as measurement values of a sensor used in the detection of the failure event.

Meanwhile, the report message does not have to include all of the pieces of information in FIG. 6, and some of the pieces of the information may be omitted.

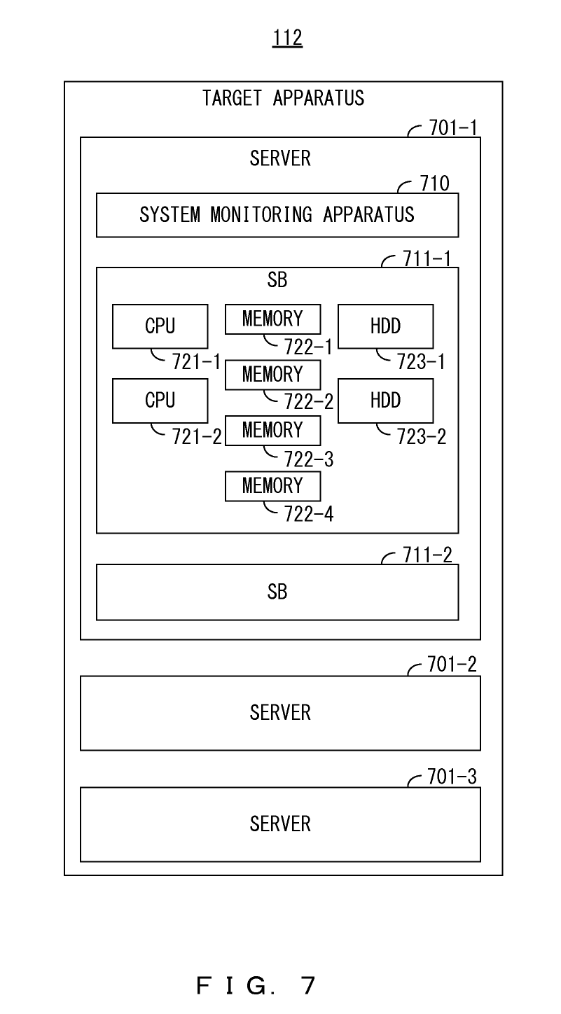

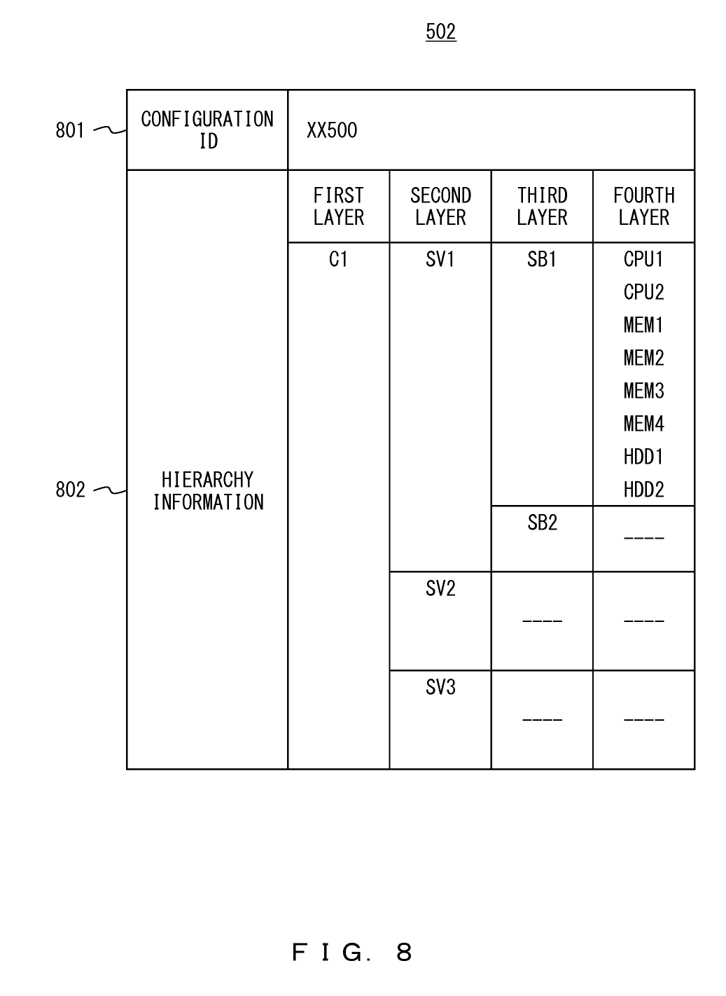

The configuration information 502 in FIG. 5 corresponds to the configuration information 211 in FIG. 2, and it indicates the inclusion relationship between the replacement units in each target apparatus 112 in the data center 101. Here, a specific example of the configuration information 502 is explained with reference to FIG. 7 and FIG. 8.

FIG. 7 illustrates a configuration example of the target apparatus 112. The target apparatus 112 in FIG. 7 includes a server 701-1 through a server 701-3, and the server 701-1 includes a system monitoring apparatus 710, a system board (SB) 711-1, and an SB 711-2.

The SB 711-1 includes Central Processing Units (CPU) 721-1 and 721-2, a memory 722-1 through a memory 722-4, a hard disk drive (HDD) 723-1, and an HDD 723-2, as its components.

In this case, the chassis of the target apparatus 112, the server 701-1 through the server 701-3, the SB 711-1, the SB 711-2, the CPU 721-1, CPU 721-2, the memory 722-1 through the memory 722-4, the HDD 723-1, and the HDD 723-2 may respectively be one replacement unit.

Hereinafter, one of the server 701-1 through the server 701-3 may be indicated and referred to as the server 701, while the SB 711-1 or SB 711-2 may be indicated and referred to as the SB 711. The same applies to the CPU 721-1 and the CPU 721-2, the memory 722-1 through the memory 722-4, and the HDD 723-1 and HDD 723-2.

The number of the CPU 721, the memory 722, or the HDD 723 included in the SB 711-1 is not limited to the number illustrated in FIG. 7, as long as it is an integer of 1 or more. Furthermore, the SB 711-1 may also include other components such as an input/output interface and the like.

The configuration of SB 711-2 may be either the same as or different from the configuration of the SB 711-1. The number of the SB 711-1 included in the server 701-1 is not limited to the number illustrated in FIG. 7, as long as it is an integer of 1 or more.

The configuration of the servers 701-2 and 701-3 may be either the same as or different from the configuration of the server 701-1. The number of the server 701 included in the target apparatus 112 is not limited to the number illustrated in FIG. 7, as long as it is an integer of 1 or more. Furthermore, the target apparatus 112 may be equipped with other pieces of hardware such as a network apparatus, a storage apparatus, and the like, instead of the server 701.

The system monitoring apparatus 710 monitors the operating state of the server 701-1, and it detects an event that occurs in the server 707-1. Then, the system monitoring apparatus 710 transmits to the management server 111 a report message including the DETECTION SOURCE ID 601 and the LOCATION ID corresponding to the system monitoring apparatus 710 and LEVEL 605 corresponding to the detected event. Meanwhile, the number of system monitoring apparatuses 710 in the server 701-1 is not limited to 1, and one system monitoring apparatus 710 may be provided for each SB 711.

FIG. 8 illustrates an example of the configuration information 502 of the target apparatus 112 in FIG. 7. The configuration information 502 in FIG. 8 includes CONFIGURATION ID 801 and hierarchy information 802. The CONFIGURATION ID 801 is the identification information of the configuration information 502, and the hierarchy information 802 is information that indicates the inclusion relationship between the replacement units in the target apparatus 112. In the example in FIG. 8, four layers, namely a first layer through a fourth layer from the higher to the lower are provided in the target apparatus 112 are provided, and the identification information of the replacement unit belonging to each layer is set.

For example, C1 in the first layer is the identification information of the chassis of the target apparatus 112, SV1 through SV3 in the second layer are the identification information of the server 701-1 through the server 701-3, respectively, and SB1 and SB2 in the third layer are the identification information of the SB 711-1 and SB 711-2, respectively. Meanwhile, CPU1 and CPU2 in the fourth layer are the identification information of the CPU 721-1 and the CPU 721-2, respectively, and MEM1 through MEM4 in the fourth layer are the identification information of the memory 722-1 through the memory 722-4, respectively. HDD1 and HDD2 in the fourth layer are the identification information of the HDD 723-1 and the HDD 723-2, respectively.

In this case, the chassis of the target apparatus 112, the server 701-1 through the server 701-3, the SB 711-1, the SB 711-2, the CPU 721-1, the CPU 721-2, the memory 722-1 through the memory 722-4, the HDD 723-1, and the HDD 723-2 are respectively a replacement unit. Furthermore, components included in SB2, SBs and components and the like included in SV1 and SV3, are also a replacement unit, and the identification information of these replacement units are also set in the hierarchy information.

The hierarchy information 802 indicates that a replacement unit indicated by identification information set in one layer includes a replacement unit indicated by identification information set in a layer that is lower than this one layer. Therefore, in the example of FIG. 8, it is understood that the chassis of the target apparatus 112 includes the server 701-1 through the server 701-3, and the server 701-1 includes the SB 711-1 and the SB 711-2. Furthermore, it is also understood that the SB 711-1 includes the CPU 721-1, the CPU 721-2, the memory 722-1 through the memory 722-4, the HDD 723-1, and the HDD 723-2.

The configuration information 502 may be set, for example, according to the mounting position and other mounting information of each of the replacement units and the configuration information of the replacement units. The mounting position and the other mounting information are collected by a collecting apparatus mounted on a piece of hardware such as a server or the like. The configuration information is stored in a storage apparatus mounted on the SB or the components.

Meanwhile, the number of layers of the hierarchy information 802 is not limited to 4, as long as it is an integer of 2 or more. In addition, the configuration information 502 does not necessarily have to be described using the hierarchy information 802, and it may be described using other information with which the inclusion relationship between replacement units may be indicated.

Next, history information 503 in FIG. 5 is information in which each of one or more report messages transmitted from the target apparatus 112-1 through the target apparatus 112-N in the past is associated with the identification information of the replacement unit that was replaced at that time. Report messages transmitted from another data center to the maintenance server 121 may also be added as the report messages included in the history information 503.

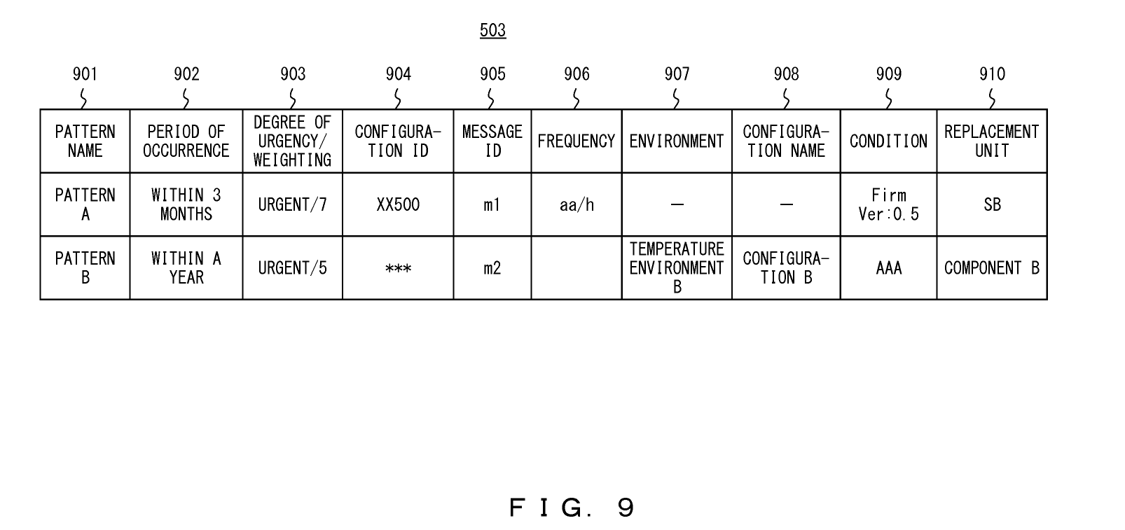

FIG. 9 illustrates an example of the history information 503. The history information 503 in FIG. 9 includes fields for PATTERN NAME 901, PERIOD OF OCCURRENCE 902, DEGREE OF URGENCY/WEIGHTING 903, CONFIGURATION ID 904, MESSAGE ID 905, FREQUENCY 906, ENVIRONMENT 907, CONFIGURATION NAME 908, CONDITION 909 and REPLACEMENT UNIT 910.

The PATTERN NAME 901 is the identification information that identifies a maintenance work that occurred in the past, and the PERIOD OF OCCURRENCE 902 represents the period in which the maintenance work occurred. The degree of urgency in the DEGREE OF URGENCY/WEIGHTING 903 represents the degree of urgency of the maintenance work, and the weighing is information of the degree of urgency in a numerical form. The CONFIGURATION ID 904 is the identification information of the configuration information 502 of the target apparatus 112 that was the target of the maintenance work, and the MESSAGE ID 905 is the identification information of the report message that triggered the maintenance work.

The FREQUENCY 906 represents the frequency of the occurrence of the event indicated by the report message, and the ENVIRONMENT 907 is information that indicates the environment such as the temperature in the target apparatus 112 at the time of the occurrence of the event. The CONFIGURATION NAME 908 is a name that represents the configuration of the target apparatus 112 at the time of the occurrence of the event, and the CONDITION 909 represents the operating condition of the target apparatus 112 at the time of the occurrence of the event. The operating condition includes, for example, the identification information of the operating system, application programs, and the like that were being executed by the target apparatus 112. The REPLACEMENT UNIT 910 represents the type of the replacement unit that was actually replaced in the maintenance work. As the types of replacement units, for example, the chassis, the server, the SB, the CPU, the memory, the HDD, and the like are used.

Meanwhile, the history information 503 does not have to include all of the fields in FIG. 9, and some of the fields may be omitted. Meanwhile, in addition to the MESSAGE ID 905, other information included in the report message such as the FAILURE INFORMATION 608, the DETAIL INFORMATION 609, the DATA 610, and the like, may be included in the history information 503.

Next, maintenance policy information 504 in FIG. 5 is information set in accordance with the maintenance policy that is the operation policy of the maintenance work. It is preferable that the maintenance policy in the data center 101 may be changed according to the situation, for each type of the replacement unit, in accordance with the operation policy of the owner. Therefore, the maintenance server 121 sets local maintenance policy information 504 respectively for each of the management servers 111 of a plurality of data centers 101 through the communication network 103.

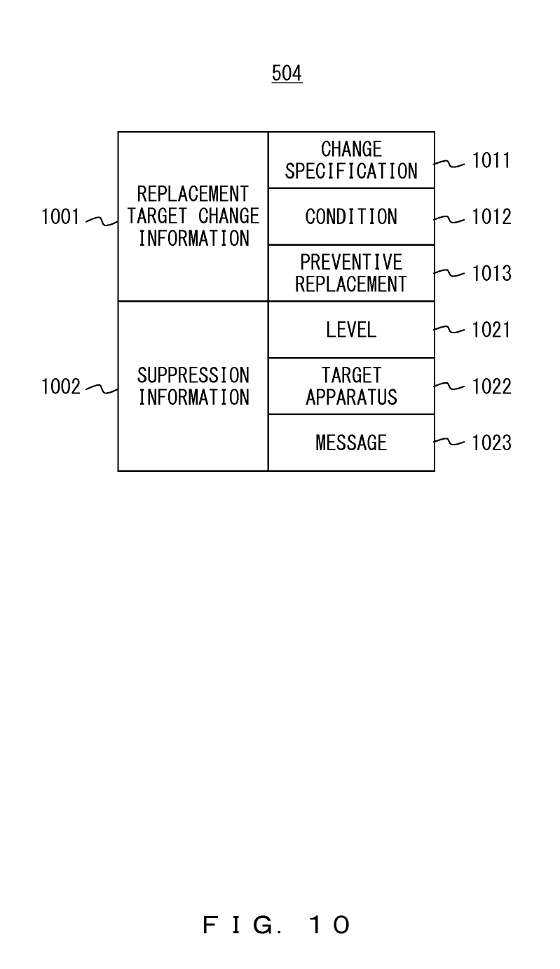

FIG. 10 illustrates an example of the maintenance policy information 504 in FIG. 5. The maintenance policy information 504 in FIG. 10 includes replacement candidate change information 1001 and suppression information 1002.

The replacement candidate change information 1001 is information that specifies a change of the replacement candidate, and it includes fields for CHANGE SPECIFICATION 1011, CONDITION 1012, and PREVENTIVE REPLACEMENT 1013. The CHANGE SPECIFICATION 1011 indicates how to execute the change of the replacement candidate. For example, one of the following is set for CHANGE SPECIFICATION 1011.

(1) Smallest unit: The smallest replacement unit (a replacement unit in the lowest layer) among the replacement units included in the replacement unit indicated by the report message is presented as the replacement candidate.

(2) Large replacement unit: The replacement unit (a replacement unit in a higher layer) that includes the replacement unit indicated by the report message is presented as the replacement candidate.

(3) Product: The sales unit (a replacement unit in a higher layer) that includes the replacement unit indicated by the report message is presented as the replacement candidate.

(4) Chassis: the whole target apparatus 112 (a replacement unit in the highest layer) that includes the replacement unit indicated by the report message is presented as the replacement candidate.

The CONDITION 1012 is information that represents a condition for the case in which the replacement work is not to be performed. For example, an occurrence of a failure event in a specific piece of hardware or in a specific component or the like is set. When a failure event that corresponds to the CONDITION 1012 occurs, no replacement work is performed, and the target apparatus 112 autonomously changes the configuration. For example, when the hardware is duplexed, the configuration is changed by switching the currently-used hardware to the standby hardware. In addition, the whole replacement unit such as the failed hardware or SB may be discarded without configuration change.

The PREVENTIVE REPLACEMENT 1013 is information that specifies whether or not a replacement work is to be performed to prevent occurrence of a fault.

The suppression information 1002 is information that specifies the suppression range of report messages, and it includes fields for LEVEL 1021, TARGET APPARATUS 1022, and MESSAGE 1023.

The LEVEL 1021 is information that represents the LEVEL 605 of report messages to be the target of suppression, and the TARGET APPARATUS 1022 is information that specifies the range of the target apparatuses 112 as the transmission source of report messages to be the target of suppression. The identification information of a chassis or the like is set as the TARGET APPARATUS 1022. The MESSAGE 1023 is information that represents the list of report messages excluded from the suppression target. For example, a certain message ID 606 is set in the list of report messages.

As described before, the replacement candidate information that indicates a replacement candidate is transmitted from the management server 111 to the maintenance server 121, and therefore, it is assumed that there is no longer a need to transmit all the report messages to the maintenance server 121 as it has been done conventionally. Therefore, for example, in order to reduce the number of report messages transmitted from the management server 111 to the maintenance server 121, the management server 111 suppresses the transmission of some report messages according to the suppression information 1002 set in the maintenance policy information 504.

By using the suppression information 1002, the amount of messages transmitted from the data center 101 to the maintenance center 102 may be reduced or customized. For example, among report messages of the levels E, W, and I mentioned before, report messages of the level I that are of a relatively low importance may be suppressed. In addition, among report messages of the level I, a report message that is particularly important may be set in MESSAGE 1023, so as to exclude it from the suppression target and to transmit it to the maintenance server 121.

Meanwhile, the maintenance policy information 504 does not have to include all of the fields in FIG. 10, and some of the fields may be omitted. For example, the CONDITION 1012 and the PREVENTIVE REPLACEMENT 1013 in the replacement candidate change information 1001 may be omitted, and the TARGET APPARATUS 1022 and the MESSAGE 1023 in the suppression information 1002 may be omitted. In addition, when there is no need to suppress report messages, the suppression information 1002 may be omitted.

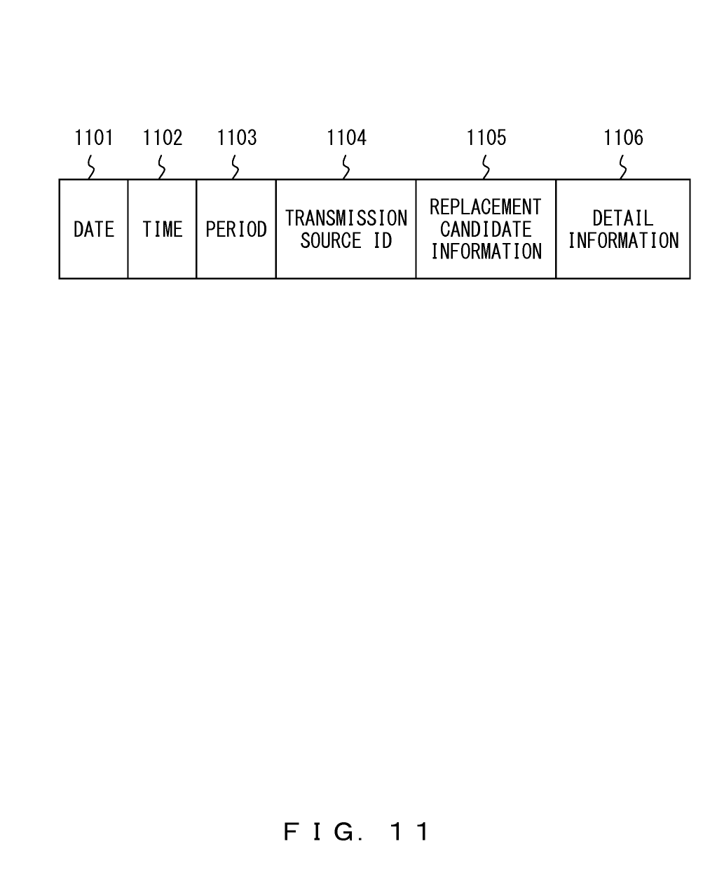

FIG. 11 illustrates the format of a maintenance message transmitted from the management server 111 to the maintenance server 121 by the replacement candidate presentation process. The maintenance message in FIG. 11 includes DATE 1101, TIME 1102, PERIOD 1103, TRANSMISSION SOURCE ID 1104, REPLACEMENT CANDIDATE INFORMATION 1105, and DETAIL INFORMATION 1106.

The DATE 1101 and the TIME 1102 represent the date and time at which the maintenance message is generated, and the PERIOD 1103 represents a message monitoring period in the replacement candidate presentation process. The management server 111 generates the maintenance message according to report messages received in this message monitoring period. The TRANSMISSION SOURCE ID 1104 is the identification information of the data center 101 to which the management server 111 that generated the maintenance massage belongs to.

The replacement candidate information 1105 is information that indicates the replacement candidate to be the target of the replacement work in the data center 101. For example, the identification information of one or more replacement units that are the replacement candidates determined by the replacement candidate presentation process is set as the replacement candidate information 1105. The DETAIL INFORMATION 1106 is information that indicates details of the failure event. For example, information items included in report messages such as the COMPONENT ID 607, the FAILURE INFORMATION 608, the DETAIL INFORMATION 609, and the like are set as the DETAIL INFORMATION 1106.

Meanwhile, the maintenance message does not have to include all of the pieces of information in FIG. 11, and some of the pieces of information may be omitted.

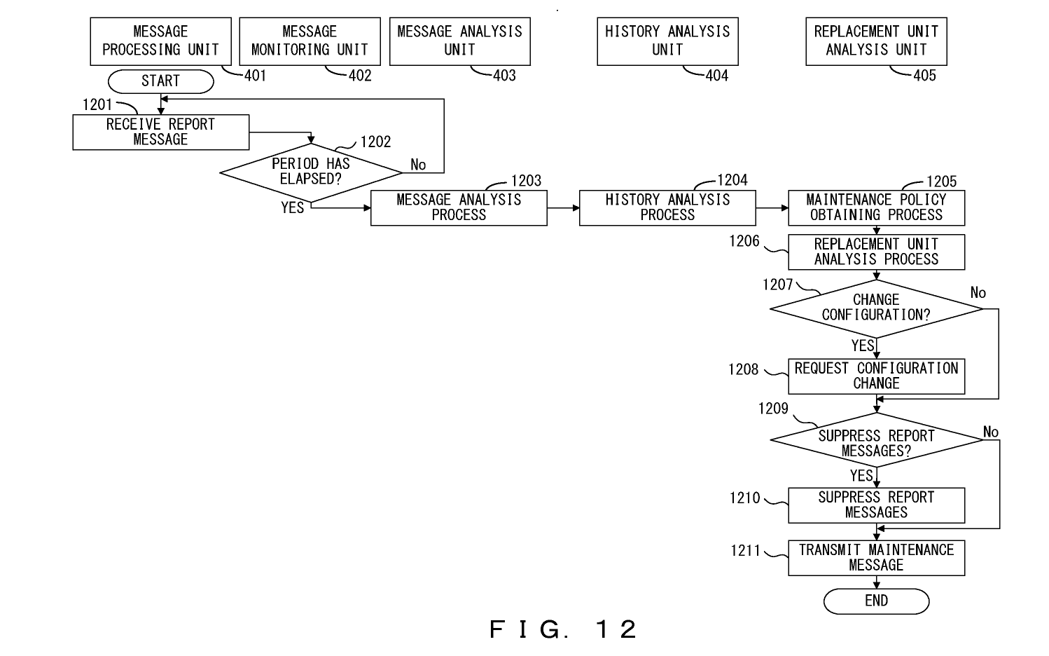

FIG. 12 is a flowchart illustrating an example of the replacement candidate presentation process performed by the management server 111 that includes the processing unit 201 in FIG. 4.

Upon receiving report messages from the target apparatus 112-1 through the target apparatus 112-N, the message processing unit 401 of the processing unit 201 stores the report messages as the report messages 501 in the storing unit 202 (step 1201). The report messages 501 may be provided in the storing unit 202 as log files, for example.

Next, the message monitoring unit 402 checks whether or not the message monitoring period has elapsed (step S1202), and when the message monitoring period has not elapsed (step 1202, NO), the message processing unit 401 repeats the process in step 1201. The message monitoring period is set in units of hours, days, weeks, months, or the like, in accordance with the operation policy of the maintenance work.

When the message monitoring period has elapsed (step 1202, YES), the message analysis unit 403 performs a message analysis process to extract report messages to be used for a replacement unit analysis process, from the report messages 501 (step 1203). In this message analysis process, report messages that are received in the message monitoring period and that have been stored as the report messages 501 become the processing target.

Next, the history analysis unit 404 performs a history analysis process to extract report messages that correspond to past report messages included in the history information 503, from the report messages 501 (step 1204). Report messages that are received in the message monitoring period and that have been stored as the report messages 501 become the processing target in this history analysis process as well.

Next, the replacement unit analysis unit 405 performs a maintenance policy obtaining process to obtain the maintenance policy information 504 (step 1205), and it performs the replacement unit analysis process according to the maintenance policy information 504 (step 1206). In the replacement unit analysis process, the target apparatus 112 to be the target of the replacement work and the replacement unit to be the replacement candidate are decided, according to COMPONENT ID 607, the configuration information 502, and the maintenance policy information 504 included in the report messages extracted in the step 1203. Then, the replacement candidate information that indicates the decided replacement candidate is generated.

Next, the replacement unit analysis unit 405 determines whether or not a configuration change of the decided target apparatus 112 is to be performed, according to the replacement candidate change information 1001 included in the maintenance policy information 504 in FIG. 10 (step 1207). Then, when the configuration change is to be performed (step 1207, YES), the replacement unit analysis unit 405 transmits a configuration change request to the target apparatus 112, and the target apparatus 112 that received the configuration change request autonomously performs the requested configuration change (step 1208).

In step 1207, a determination to perform a configuration change is made when a failure event that corresponds to CONDITION 1012 in the replacement candidate change information 1001 occurs, and a configuration change request is transmitted to the target apparatus 112 in which the failure event occurred.

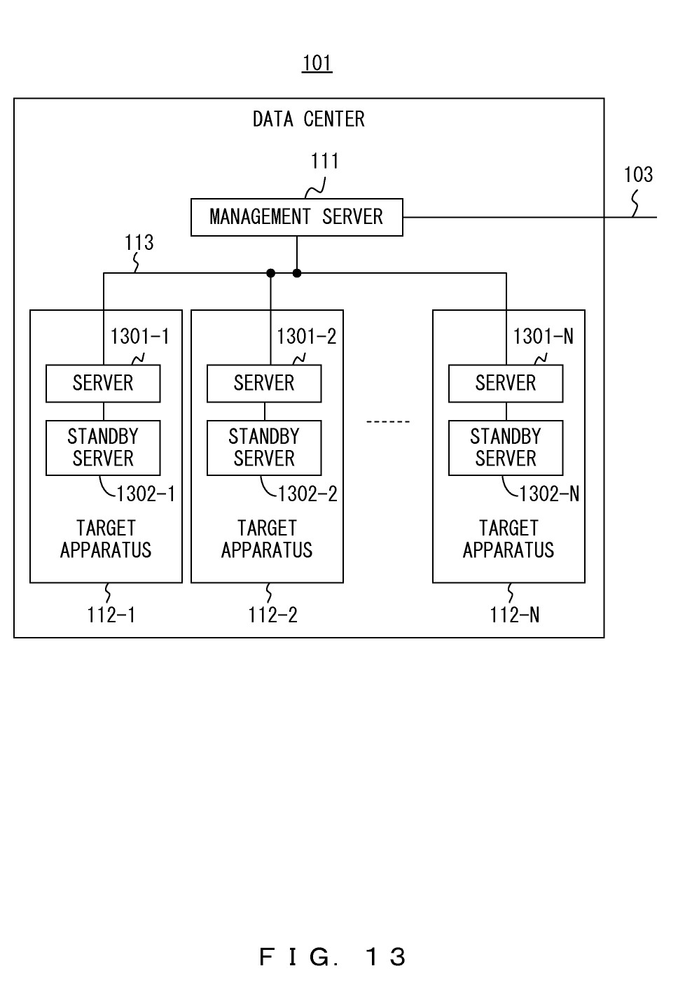

FIG. 13 illustrates an example in which the target apparatus 112 autonomously performs a configuration change. In the data center 101 in FIG. 13, the server 1301-i of the target apparatus 112-i (i=1, 2, . . . , N) is duplexed with a standby server 1302-i. Then, upon receiving a configuration change request from the management server 111, the target apparatus 112-i switches the currently-used server to the standby server 1302-i, to change the configuration.

Accordingly, when a failure event such as a failure of an important component occurs, it becomes possible to change the whole hardware to continue the service operation, without execution of a replacement work by the maintenance operator. The server 1301-i that is no longer the currently-used server according to the switching may be collected in a batch on a regular basis and may be replaced with a new standby server.

In step 1208, the configuration may be changed by degeneration with a replacement unit such as the SB, the CPU, the memory, or the like, instead of switching the replacement unit such as the server or the like to a standby apparatus.

Next, the replacement unit analysis unit 405 determines whether or not report messages are to be suppressed, according to the suppression information 1002 included in the maintenance policy information 504 in FIG. 10 (step 1209). Then, when report messages are to be suppressed (step 1209, YES), the replacement unit analysis unit 405 suppresses the transmission of report messages to the maintenance server 121 (step 1210).

In step 1209, a determination to suppress report messages is made when the suppression target is set in LEVEL 1021 or in TARGET APPARATUS 1022 in the suppression information 1002. In this case, among report messages received from the target apparatuses 112 corresponding to the information in TARGET APPARATUS 1022, the report messages of the LEVEL 605 corresponding to the information in LEVEL 1021 become the suppression target. Meanwhile, report messages corresponding to the information in MESSAGE 1023 are excluded from the suppression target.

By suppressing report messages, the amount of messages transmitted from the data center 101 to the maintenance center 102 may be controlled so as to prevent the amount from becoming huge. In addition, even when report messages are to be suppressed, report messages that are particularly important may be set separately in MESSAGE 1023 to allow them to be transmitted.

Next, the replacement unit analysis unit 405 transmits the maintenance message including the replacement candidate information generated by the replacement unit analysis process to the maintenance server 121 (step 1211). The maintenance server 121 displays information to present the replacement candidate and the like on a display screen, according to the maintenance message received from the management server 111. Accordingly, the maintenance operator of the maintenance center 102 may perform a work to replace the replacement unit corresponding to the presented replacement candidate.

Meanwhile, when a configuration change is performed in step 1208, the replacement work is not performed in some cases. In a case in which the replacement work is not performed, the transmission of the maintenance message may be omitted, since there is no need to present a replacement candidate to the maintenance operator.

When the configuration change is not to be performed (step 1207, NO), the replacement unit analysis unit 405 performs the process in step 1209 and the subsequent processes, and when report messages are not to be suppressed (step 1209, NO), it performs the process in step 1211.

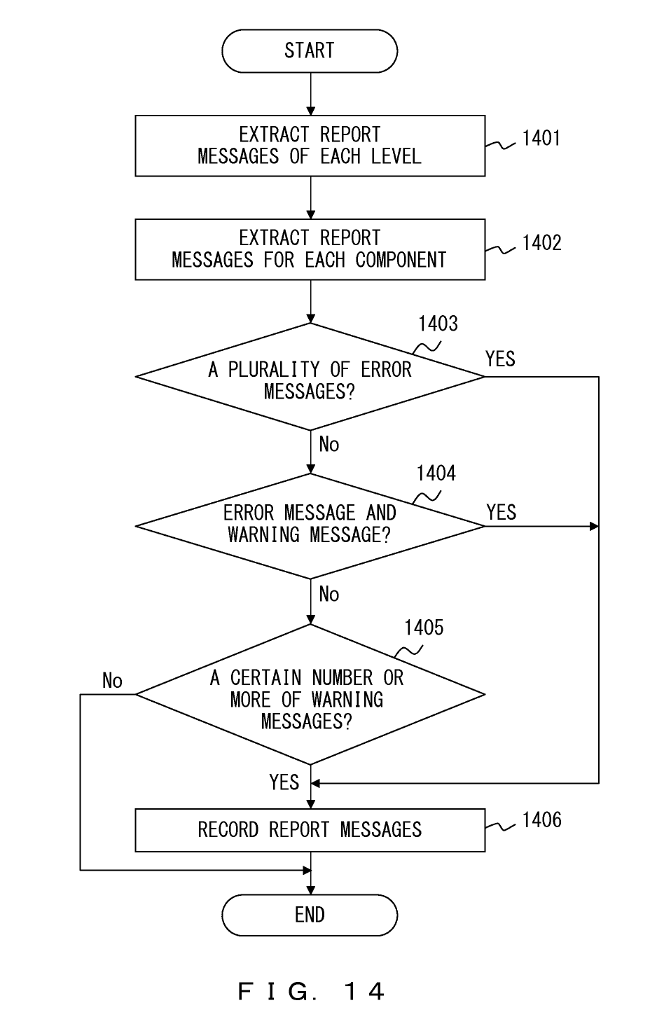

Next, with reference to FIG. 14 through FIG. 17, processes performed in step 1203 through step 1206 in FIG. 12 are explained.

FIG. 14 is a flowchart illustrating an example of the message analysis process in step 1203 in FIG. 12. The message analysis unit 403 first sorts report messages received in the message monitoring period by the level indicated by LEVEL 605, to extract report messages of each of the levels E, W, and I (step 1401).

Next, the message analysis unit 403 sorts the report messages of each of the levels by the component indicated by COMPONENT ID 607, to extract report messages for each component (step 1402). Then, the message analysis unit 403 checks whether or not a plurality of report messages of the level E that have the same COMPONENT ID 607 have been extracted (step 1403).

When a plurality of report messages of the level E that have the same COMPONENT ID 607 have been extracted (step 1403, YES), the message analysis unit 403 records the report messages in the storing unit 202 (step 1406).

On the other hand, when a plurality of report messages of the level E that have the same COMPONENT ID 607 have not been extracted (step 1403, NO), the message analysis unit 403 next checks whether or not a combination of report messages of the level E and the level W that have the same COMPONENT ID 607 has been extracted (step 1404).

When a combination of report messages of the level E and the level W that have the same COMPONENT ID 607 has been extracted (step 1404, YES), the message analysis unit 403 records the report messages in the storing unit 202 (step 1406). Meanwhile, when a plurality of report messages of the level E that have the same COMPONENT ID 607 have been extracted, the plurality of report messages are recorded. In a similar manner, when a plurality of report messages of the level W that have the same COMPONENT ID 607 have been extracted, the plurality of report messages are recorded.

On the other hand, when a combination of report messages of the level E and the level W that have the same COMPONENT ID 607 has not been extracted (step 1404, NO), the message analysis unit 403 checks whether or not a certain number or more of report messages of the level W that have the same COMPONENT ID 607 have been detected (step 1405).

When a certain number or more of report messages of the level W that have the same COMPONENT ID 607 have been detected (step 1405, YES), the message analysis unit 403 records the report messages in the storing unit 202 (step 1406). On the other hand, when a certain number or more of report messages of the level W that have the same COMPONENT ID 607 have not been detected (step 1405, NO), the message analysis unit 403 terminates the process.

According to a message analysis process such as the one described above, the report messages of the level E that are error messages or the report messages of the level W that are warning messages generated in a concentrated manner in a certain period due to a fault of the same component may be identified.

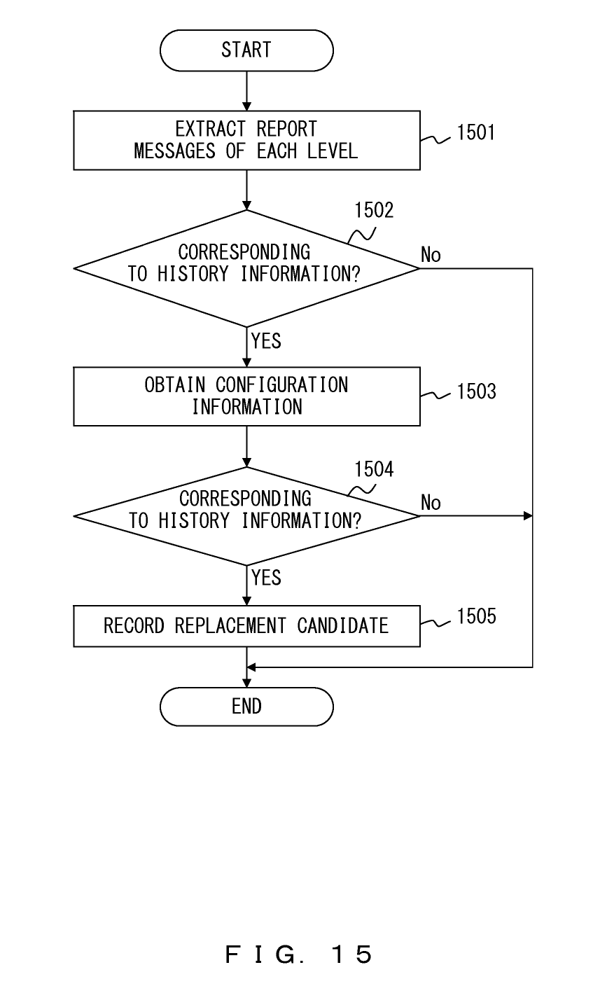

FIG. 15 is a flowchart illustrating an example of the history analysis process in step 1204 in FIG. 12. The history analysis unit 404 first sorts report messages received in the message monitoring period by the level indicated by LEVEL 605, to extract report messages of each of the levels E, W, and I (step 1501).

Next, the history analysis unit 404 refer to the history information 503 in the storing unit 202 and it checks whether or not there is any entry corresponding to each of the extracted report messages (step 1502). Here, for example, a search is performed for an entry in the history information 503 that has the MESSAGE ID 905 corresponding to the MESSAGE ID 606 of the report message.

When there is an entry corresponding to the report message (step 1502, YES), the history analysis unit 404 next refers to the storing unit 202, to obtain the configuration information 502 that includes the identification information of the chassis of the target apparatus 112 included in the LOCATION ID 602 of the report message (step 1503). Then, the history analysis unit 404 compares the CONFIGURATION ID 801 of the obtained configuration information 502 and the CONFIGURATION ID 904 of the entry in the history information 503 (step 1504).

When the CONFIGURATION ID 801 of the configuration information 502 and the CONFIGURATION ID 904 of the entry in the history information 503 match (step 1504, YES), the history analysis unit 404 records the replacement candidate in the storing unit 202 according to the information in the REPLACEMENT UNIT 910 of the entry (step 1505). Here, for example, among the identification information of the replacement units included in the configuration information 502, the identification information of the replacement unit that corresponds to the type indicated by the REPLACEMENT UNIT 910 is recorded as a replacement candidate.

When there is no entry in the history information 503 corresponding to the report message (step 1502, NO), or when the CONFIGURATION ID 801 of the configuration information 502 and the CONFIGURATION ID 904 of the entry in the history information 503 do not match (step 1504, NO), the history analysis unit 404 terminates the process.

Meanwhile, when the FAILURE INFORMATION 608, the DETAIL INFORMATION 609, the DATA 610, or the like in FIG. 6 is included in the history information 503, a search may be performed in step 1502 for an entry in the history information 503 that has information corresponding to those information included in each report message.

In addition, in step 1502, when there are a plurality of entries in the history information 503 corresponding to the report message and DEGREE OF URGENCY/WEIGHTING 903 are set in these entries, a certain number of entries whose weighting is greater may be preferentially selected.

According to a history analysis process such as the one described above, it becomes possible to present as the current replacement candidate a replacement unit that is the same type as the replacement unit exchanged according to a failure event occurred in the past. In addition, by using the history information 503 that includes the histories in other data centers managed by the maintenance center 102, the accuracy of the replacement candidate may be improved according to the results of replacement works performed in the other data centers.

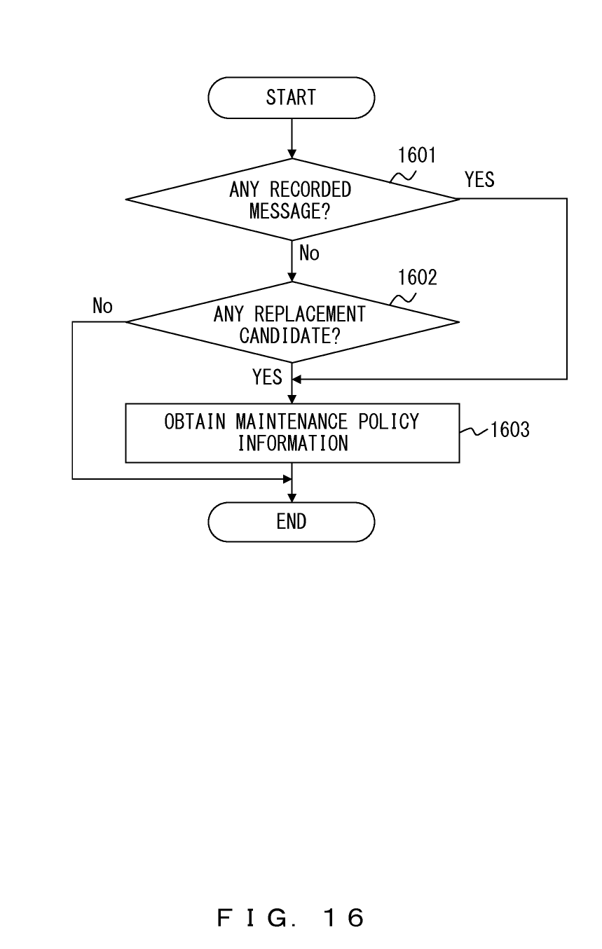

FIG. 16 is a flowchart illustrating an example of the maintenance policy obtaining process in step 1205 in FIG. 12. The replacement unit analysis unit 405 first checks whether or not there are any report messages recorded in step 1406 in FIG. 14 (step 1601). When there are recorded report messages (step 1601, YES), the replacement unit analysis unit 405 obtains the maintenance policy information 504 from a storing unit 1603 (step 1603).

On the other hand, when there is no recorded report message (step 1601, NO), the replacement unit analysis unit 405 checks whether or not there is any replacement candidate recorded in step 1505 in FIG. 15 (step 1602). When there is a recorded replacement candidate (step 1602, YES), the replacement unit analysis unit 405 obtains the maintenance policy information 504 from the storing unit 1603 (step 1603). When there is no recorded replacement candidate (step 1602, NO), the replacement unit analysis unit 405 terminates the process.

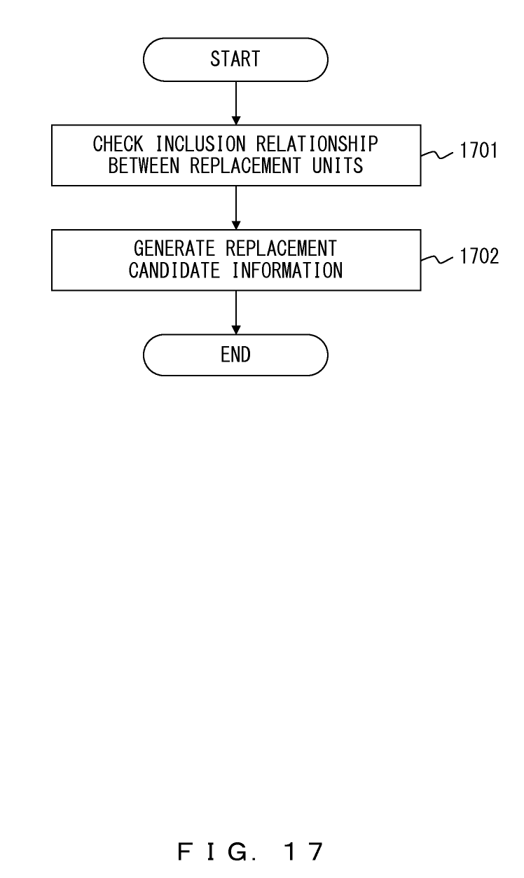

FIG. 17 is a flowchart illustrating an example of the replacement unit analysis process in step 1206 in FIG. 12. The replacement unit analysis unit 405 first checks the inclusion relationship between the replacement units, using the report messages recorded in step 1406 in FIG. 14 and the replacement candidate recorded in step 1505 in FIG. 15 (step 1701).

Here, for example, the check of the inclusion relationship between the replacement units is performed with the replacement units indicated by the COMPONENT ID 607 included in the recorded report messages and with the replacement units indicated by the recorded replacement candidates as the processing target. At this time, the configuration information 502 including the identification information of the chassis of the target apparatus 112 included in LOCATION ID 602 in a recorded report massage and the configuration information 502 used when determining a recorded replacement candidate are used for the check of the inclusion relationship. Furthermore, the target apparatus 112 indicated by the LOCATION ID 602 is decided as the target of the replacement work.

Then, the replacement unit analysis unit 405 changes the replacement candidate in accordance with CHANGE SPECIFICATION 1011 in the maintenance policy information 504, and it generates the replacement candidate information 1105 that includes the identification information of the changed replacement candidate (step 1702).

For example, when Large replacement unit is set as CHANGE SPECIFICATION 1011, a larger replacement unit that includes the processing-target replacement unit is decided as the replacement candidate after change. In a case in which the configuration information 502 in FIG. 8 is used, when MEM1 and MEM2 in the fourth layer are included in the processing target, SB1 in the third layer that includes MEM1 and MEM2 is decided as the replacement candidate after change, for example.

Meanwhile, when Product is set as the CHANGE SPECIFICATION 1101, the sales unit that includes the processing-target replacement unit is decided as the replacement candidate after change. For example, when MEM1 and MEM2 in the fourth layer are included in the processing target and the server is the sales unit, SV1 in the second layer that includes MEM1 and MEM2 is decided as the replacement candidate after change.

Then, when Chassis is set as CHANGE SPECIFICATION 1011, the chassis of the target apparatus 112 that includes the processing-target replacement unit is decided as the replacement candidate after change. For example, when MEM1 and MEM2 in the fourth layer are included in the processing target, C1 in the first layer that includes MEM1 and MEM2 is decided as the replacement candidate after change.

The replacement candidate after change does not have to be one replacement unit, and it may be a plurality of replacement units. When there are a plurality of replacement units as replacement candidates, the replacement candidate information 1105 may be generated while setting priorities in an order preferentially from a replacement units in the first layer to replacement units in the lower layers included in the configuration information 502. Furthermore, the processing-target replacement unit itself may be included in the replacement candidate information 1105 as a replacement candidate.

For example, the replacement candidate information 1105 that includes C1 in the first layer as the first candidate, SV1 in the second layer as the second candidate, SB1 in the third layer as the third candidate, and MEM1 and MEM2 in the fourth layer as the fourth candidates may be generated.

According to such a replacement unit analysis process as the one described above, it becomes possible to present as a replacement candidate not only an individual component indicated by the COMPONENT ID 607 but also a larger replacement unit that includes one or more components that may have failed. In addition, it also becomes possible to present as a replacement candidate a larger replacement unit exchanged according to a failure event that occurred in the past. For example, when a failure event occurs again in a memory that was replaced in the past, the whole SB that includes the memory may be presented as the replacement candidate, instead of replacing the same memory again. Accordingly, replacement works for the maintenance operator are simplified to a large extent.

For example, when error messages or warning messages are generated from a plurality of memories mounted on one SB, it becomes possible to determine that a plurality of failures are occurring on the same SB and to generate the replacement candidate information 1105 that specifies the SB as a replacement candidate. A maintenance message including this replacement candidate information 1105 is sent to the maintenance center 102 separately from individual error messages and warning messages. Accordingly, it becomes possible for the maintenance operator to choose whether to replace a plurality of memories or to replace the whole SB in one replacement work.

Besides the hardware configuration of the target apparatus 112, information about the logical configuration of the hardware, the connection configuration with the network apparatus, and the like may be set as the configuration information 502. In this case, the replacement unit analysis unit 405 may obtain a replacement candidate based on a fault in the logical interface on the SB or a fault between the communication networks, for example.

According to the replacement candidate presentation process described above, it becomes possible to change the replacement candidate flexibly according to a plurality of types of report messages from the system monitoring apparatus 710 in the target apparatus 112. Accordingly, even when a plurality of failure events of hardware occurs, the workload for the maintenance operator may be reduced by avoiding redundant replacement works depending on the situation. In addition, it is possible to reduce report messages transmitted to the maintenance center 102, and therefore, the workload for the maintenance operator is further reduced.

In addition, it becomes possible to distinguish a case in which some components of the hardware are to be replaced and a case in which the whole hardware is to be replaced without component replacement to simplify the maintenance work to a large extent, using the maintenance policy information 504. Furthermore, it becomes possible to compare and consider the cost of the replacement work and the costs of replacement units, to optimize the maintenance work.

Meanwhile, it is desirable that the maintenance policy information 504 set for the management server 111 of each data center 101 may be changed according to the types and the number of pieces of hardware included in the target apparatus 112, or according to the operating state of the target apparatus 112, in accordance with the operation policy of the maintenance work.

In addition, in the maintenance center 102, various items of system information, hardware information, report messages, and the like may be collected from a plurality of data centers 101 for maintenance works. Then, statistical data processing may be applied to the collected information items, and the history information 503 may be updated according to the collected information items and the result of the data processing. Therefore, it is desirable that the updated history information 503 may be reflected in the history information 503 set in the management server 111 in the data center 101.

Therefore, a procedure to change the history information 503 and the maintenance policy information 504 for each data center 101 by remote control from the maintenance center 102 may be provided.

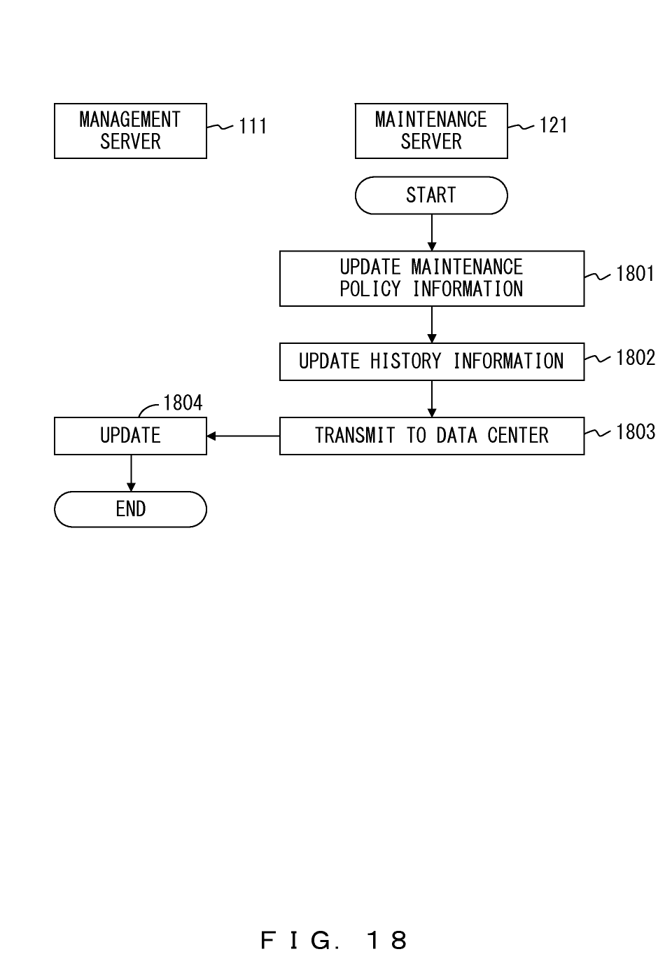

FIG. 18 is a flowchart illustrating an example of a process in which the maintenance server 121 of the maintenance center 102 changes the history information 503 and the maintenance policy information 504. The maintenance server 121 first updates the maintenance policy information 504, according to the types and number of pieces of hardware included in the target apparatus 112, or according to the operating state of the target apparatus 112 (step 1801).

Next, the maintenance server 121 applies statistical data processing to the information items collected from a plurality of data centers 101, and it updates the history information 503 (step 1802). Then, the maintenance server 121 transmits the updated history information 503 and maintenance policy information 504 to the management server 111 (step 1803). Then, the management server 111 updates the history information 503 and the maintenance policy information 504 in the storing unit 202, using the received history information 503 and maintenance policy information 504 (step 1804).

In step 1803, it is also possible to transmit the history information 503 selectively to another data center that has similar pieces of hardware or a similar system to those of the data center in which a failure event occurred, or to another data center in which a similar operation is performed.

As described above, by forwarding history information of failure events that occurred in a certain data center to another data center with a similar operating environment, it becomes possible to refer to maintenance works performed for the same type of apparatus in another data center and to decide the replacement candidate efficiently. In addition, the accuracy of the replacement candidate may be improved by changing the information of the DEGREE OF URGENCY/WEIGHTING 903 included in the history information 503, according to the result of data processing applied by the maintenance server 121.

Each of the flowcharts illustrated in FIG. 12 and FIG. 14 through FIG. 18 is given merely as an example, and some of the processes may be omitted or changed according to the configuration or the condition of the data center 101 or the maintenance center 102. For example, when there is no need to refer to failure events occurred in the past, the history information 503 in FIG. 5 and the process in step 1204 in FIG. 12 may be omitted. In addition, when there is no need to suppress report messages, the suppression information 1002 and the processes in steps 1209 and 1210 in FIG. 12 may be omitted.

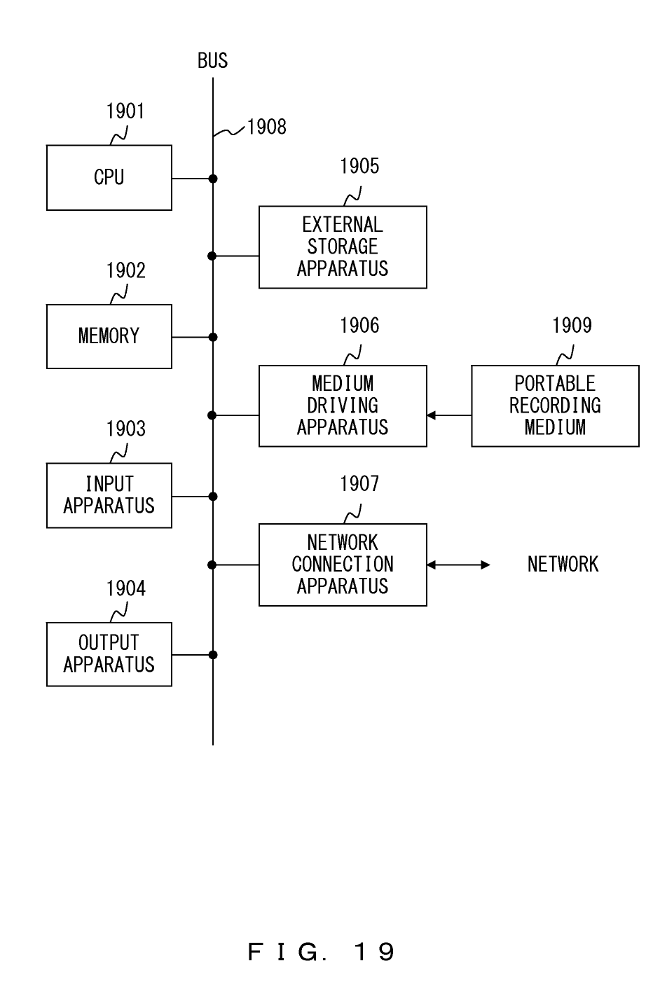

The management server 111 and the maintenance server 121 in FIG. 1 may be realized using an information processing apparatus (a computer) such as the one illustrated in FIG. 19, for example.

The information processing apparatus in FIG. 19 includes a CPU 1901 (a processor), a memory 1902, an input apparatus 1903, an output apparatus 1904, an external storage apparatus 1905, a medium driving apparatus 1906, and a network connection apparatus 1907. These are connected to each other by a bus 1908.

The memory 1902 is, for example, a semiconductor memory such as a Read Only Memory (ROM), a Random Access Memory (RAM), a flash memory, or the like, which stores a program and data used for processing. For example, the CPU 1901 operates as the processing unit 201 in FIG. 2 and performs the replacement candidate presentation process by executing a program using the memory 1902. The memory 1902 may also be used as the storing unit 202 in FIG. 2.

The input apparatus 1903 is, for example, a keyboard, a pointing device, and the like, which is used for inputting instructions and information from a user or an operator. The output apparatus 1904 is, for example, a display apparatus, a printer, a speaker, and the like, which is used for outputting enquiries to the user or to the operator, or for outputting processing results. The output apparatus 1904 may also be used as the output unit 203 in FIG. 2.

The external storage apparatus 1905 is, for example, a magnetic disk apparatus, an optical disk apparatus, and magneto-optical disk apparatus, a tape apparatus, or the like. A hard disk drive is also included in the external storage apparatus 1905. The information processing apparatus is able to store a program and data in the external storage apparatus 1905 and to use them by loading them onto the memory 1902.

The medium driving apparatus 1906 drives a portable recording medium 1909 to access its recorded content. The portable recording medium 1909 is a memory device, a flexible disk, an optical disk, a magneto-optical disk, or the like. A Compact Disk Read Only Memory (CD-ROM), a Digital Versatile Disk (DVD), a Universal Serial Bus (USB) memory, and the like are also used as the portable recording medium 1909. The user or the operator may store a program and data in the portable recording medium 1909 and may use them by loading them onto the memory 1902.

As described above, a physical (non-transitory) recording medium such as the memory 1902, an external storage apparatus 1905, and the portable recording medium 1909 is used as the computer-readable recording medium that stores a program and data used for various processes.

The network connection apparatus 1907 is a communication interface that is connected to the communication networks 103 and 113 and that performs data conversion associated with the communication. One network connection apparatus 1907 may be provided respectively for each of the communication networks 103 and 113. The information processing apparatus may also receive a program and data from an external apparatus through the network connection apparatus 1907 and may use them by loading them onto the memory 1902. The network connection apparatus 1907 may also be used as the output unit 203 in FIG. 2.

Meanwhile, the information processing apparatus does not have to include all of the constituent elements in FIG. 19, and some of the constituent elements may be omitted according to the purpose or conditions. For example, when the information processing apparatus does not directly dialogue with the user or the operator, the input apparatus 1903 and the output apparatus 1904 may be omitted, and when no access is to be made to the portable recording medium 1909, the medium driving apparatus 1906 may be omitted.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A replacement candidate presentation method executed by a computer, the replacement candidate presentation method comprising:
according to configuration information that is stored in a memory and that indicates an inclusion relationship between a plurality of replacement units in a target apparatus that is a target of a replacement work by identification information that identifies the plurality of replacement units, determining, by a processor, first identification information indicating a first replacement unit that includes a second replacement unit in the target apparatus indicated by second identification information included in report information transmitted from the target apparatus; and
outputting replacement candidate information including the first identification information for indicating that the first replacement unit is a replacement candidate.

2. The replacement candidate presentation method according to claim 1, wherein
the memory further stores replacement candidate change information that specifies a change of the replacement candidate; and
the determining the first identification information determines the first identification information indicating the first replacement unit that includes the second replacement unit when the replacement candidate change information specifies a change of the replacement candidate to a larger replacement candidate.

3. The replacement candidate presentation method according to claim 2, wherein
the replacement candidate change information is updatable by another computer that is different from the computer executing the replacement candidate presentation method.

4. The replacement candidate presentation method according to claim 1, wherein
the memory further stores history information in which each of one or more pieces of report information transmitted from the target apparatus or from another target apparatus is correlated with a type of a replaced replacement unit; and
when the report information transmitted from the target apparatus corresponds to one of the one or more pieces of report information included in the history information, the replacement candidate information includes identification information of a third replacement unit of a type corresponding to the report information included in the history information.

5. The replacement candidate presentation method according to claim 4, wherein
the history information is updatable by another computer that is different from the computer executing the replacement candidate presentation method.

6. The replacement candidate presentation method according to claim 1, wherein
the memory further stores suppression information that specifies a suppression range of the report information; and
when the report information transmitted from the target apparatus is included in the suppression range, the processor suppresses an output of the report information transmitted from the target apparatus.

7. The replacement candidate presentation method according to claim 6, wherein
the suppression information is updatable by another computer that is different from the computer executing the replacement candidate presentation method.

8. An information processing apparatus comprising:
a memory configured to store configuration information that indicates an inclusion relationship between a plurality of replacement units in a target apparatus that is a target of a replacement work by identification information that identifies the plurality of replacement units;
a processor configured to determine, according to the configuration information, first identification information indicating first replacement unit that includes a second replacement unit in the target apparatus indicated by second identification information included in report information transmitted from the target apparatus; and
an output interface configured to output replacement candidate information including the first identification information for indicating that the first replacement unit is a replacement candidate.

9. A non-transitory computer-readable recording medium having stored therein a program for causing a computer to execute a process comprising:
according to configuration information that is stored in a memory and that indicates an inclusion relationship between a plurality of replacement units in a target apparatus that is a target of a replacement work by identification information that identifies the plurality of replacement units, determining, by a processor, first identification information indicating a first replacement unit that includes a second replacement unit in the target apparatus indicated by second identification information included in report information transmitted from the target apparatus; and
outputting replacement candidate information including the first identification information for indicating that the first replacement unit is a replacement candidate.
